(19) United States
(12) Patent Application Publication
(10) Pub. No.: US 2014/0190879 A1
(43) Pub. Date: Jul. 10, 2014

(54) Bucket Arrangement, Treatment Station, Sink Arrangement and Retrofitting Method

(71) Applicant: Ronald Alexander (Scot) Young, West Midlands (GB)

(72) Inventor: Ronald Alexander (Scot) Young, West Midlands (GB)

(21) Appl. No.: 13/979,429

(22) PCT Filed: Jan. 12, 2012
(86) PCT No.: PCT/GB2012/050054

§ 371 Date: Sep. 25, 2013

(30) Foreign Application Priority Data
Jan. 12, 2011 (GB) 1100476.9

(51) Int. Cl. C02F 1/32; C02F 1/50

(52) U.S. Cl. CPC C02F 1/32; C02F 1/50
USPC 210/198.1; 250/435

(57) ABSTRACT

A bucket arrangement includes a bucket configured to contain a volume of liquid for use in cleaning a surface, a treatment station, a flow path for liquid from the liquid volume to the treatment station, and a flow path for liquid from the treatment station to return the liquid to the liquid volume after treatment by the treatment station. The treatment station includes a source of ultra-violet radiation configured to expose the liquid in the treatment station to ultra-violet radiation to treat the liquid and/or a silver-based antibacterial device configured to expose the liquid in the treatment station to silver to treat the liquid.

### DESCRIPTION OF INVENTION

This invention relates to a bucket arrangement, a treatment station, a sink arrangement, and a retrofitting method. Embodiments of the bucket arrangement include a bucket configured to hold a liquid volume, the liquid being used for washing surfaces.

More particularly but not exclusively the bucket of the bucket arrangement is a mop bucket which holds a volume of liquid for washing floors.

In each case, in use liquid from the bucket is transferred to the surface to be cleaned, on a cloth or mop for example, and the cloth/mop is returned to the bucket for rinsing. Thus the liquid in the bucket becomes increasingly soiled and the level of bacteria in the liquid volume increases, until the liquid volume is changed with a clean liquid volume.

It is established practice to add to the liquid volume, which usually is at least predominantly water, a chemical additive or additives. This additive or additives may act to agglomerate or flocculate dirt particles in the liquid, which may then sink and collect in a sump of the bucket where this is provided, and the additive or additives may chemically kill the bacteria. Thus the adding of such additives prolong the time for which the liquid volume may be used before a liquid change is required.

However the discharge of large amounts of soiled liquid containing chemicals to the environment, e.g. down drains, is environmentally undesirable.

It is known that Ultra-Violet (UV) radiation kills bacteria. It has been proposed to use UV radiation in many applications to kill bacteria.

It is known to provide silver in cleaning products—such as silver strips in cloths—for anti-bacterial purposes. It is also known to provide arrangements which subject sewage to silver ions with the aim of treating the sewage (see GB622691).

Embodiments of the present invention seek to ameliorate one or more problems associated with the prior art.

According to an aspect of the present invention we provide a bucket arrangement including: a bucket configured to contain a volume of liquid for use in cleaning a surface; a treatment station; a flow path for liquid from the liquid volume to the treatment station; and a flow path for liquid from the treatment station to return the liquid to the liquid volume after treatment by the treatment station, wherein the treatment station includes a source of ultra-violet radiation configured to expose the liquid in the treatment station to ultra-violet radiation to treat the liquid and/or a silver-based antibacterial device configured to expose the liquid in the treatment station to silver ions to treat the liquid.

The treatment station may include a closed chamber in which the source of ultra-violet radiation and/or silver-based antibacterial device are located.

The treatment station may include the source of ultra-violet radiation which is configured to expose the liquid to the ultra-violet radiation as the liquid flows though the treatment station.

The treatment station may include the silver-based antibacterial device which is configured to expose the liquid to silver ions as the liquid flows through the treatment station. The bucket arrangement may further include a pump wherein the liquid is pumped to and/or from the treatment station by the pump. The pump and treatment station may be housed in a common housing. The treatment station may be configured to be submersed in the liquid volume within the bucket. The treatment station may be configured to be external to the liquid volume. The treatment station may be outside the bucket with the flow paths to and from the liquid volume passing through a bucket wall of the bucket. The treatment station may be located within the bucket. The bucket arrangement may further include a wringer mechanism attached to the bucket and the treatment station is supported by the wringer mechanism. The silver-based antibacterial device may include a silver containing mesh. The silver-based antibacterial device may be configured to expose the liquid in the treatment station to silver in the form of silver ions to treat the liquid. The silver-based antibacterial device may include at least one silver containing electrode. The bucket arrangement may further include a battery wherein electrical power for the treatment station is provided by the battery. The battery may be a re-chargeable battery. The battery may be accommodated in a common housing with the treatment station. The battery may be housed within a battery compartment externally of the bucket. The battery may be removable from the bucket. The bucket arrangement may further include a mains electrical supply adaptor configured for connection to a mains electrical supply. The bucket arrangement may further include wheels attached to the bucket or a wheeled carriage attachable to the bucket. The bucket may include a substantially flat base such that the bucket can be supported directly on a substantially flat ground surface or work top. The bucket may be configured to engage a support structure which includes a substantially flat base such that the bucket can be supported by the support structure on a substantially flat ground surface or work top.

Another aspect provides a treatment station for treating a volume of liquid for use in cleaning a surface, the treatment station including: a source of ultra-violet radiation to which liquid in the treatment station is exposed to treat the liquid and/or a silver-based antibacterial device configured to expose liquid in the treatment station to silver ions to treat the liquid; an input conduit providing a flow path for liquid from a liquid volume to the source of ultra-violet radiation and/or silver-based antibacterial device; and an output conduit providing a flow path for liquid from the source of ultra-violet radiation and/or silver-based antibacterial device to return the liquid to the liquid volume after treatment by the treatment station, such that, in use, liquid from the liquid volume is drawn into the treatment station through the input conduit to the source of ultra-violet radiation and/or silver-based antibacterial device for treatment and then released from the treatment station.

Another aspect provides a sink arrangement including: a sink; one or more sources of liquid configured to supply liquid to the sink; and a treatment station as above, wherein the volume of liquid is a volume of liquid contained in the sink.

Another aspect provides a method of retrofitting a bucket arrangement with a treatment station, the method including: providing a bucket; providing a treatment station as above such that the treatment station is configured to treat liquid in the bucket.

Providing the treatment station may further comprise positioning the treatment station within the bucket.

According to some embodiments, at least the use of chemical additive for killing bacteria can be minimised or avoided altogether, and thus when soiled liquid is discharged, the liquid will have a less harmful effect on the environment.

The treatment station 30 may include a closed chamber, to reduce any risk of the UV radiation being seen by a user. The liquid may be exposed to the UV radiation as the liquid flows though the treatment station.

The liquid may be pumped to and/or from the treatment station by a pump.

In one example, the treatment station is immersed in the liquid volume within the bucket in which case the pump may be a submersible self-priming pump. However, the treatment station need not be submersed in the liquid volume, but may be external to the liquid volume (e.g. outside the bucket with the flow paths to and from the liquid volume passing through a bucket wall, or within the bucket but above the level of the liquid volume in the bucket). The treatment station may be supported by a wall of the bucket, or where the bucket has a wringer mechanism attached to it, the treatment station may be supported by the wringer mechanism.

The pump and the treatment station may be housed in a common housing, although may be separate as required. For example, the pump may be submersed in the liquid in the container whilst the treatment station could be external to the bucket. Various permutations are possible.

The treatment station requires electrical power for its operation. Electrical power may be provided by a battery, which may be of the re-chargeable kind. The battery may be accommodated in a common housing with the treatment station, or (for example, where the pump is separate from the treatment station) within a housing of the pump, or in a separate housing or within a bucket battery compartment externally of the bucket.

Where the battery is re-chargeable, the battery may be removable from the bucket for charging, although in another example, there may be provided an integrated battery charging point (e.g. a connector) to which an electrical connection may be made.

The pump may be electrically powered from the battery, although a separate battery for the pump may be provided as required, which separate battery may be accommodated with or separately from the battery which powers the treatment station.

The bucket may be wheeled or at least in use may be carried on a wheeled carriage, so that the extra weight of the battery or batteries is not a problem for a user or, at least, the effect of the extra weight on the user is reduced.

Embodiments of the invention are described, by way of example, only with reference to the accompanying drawings in which:

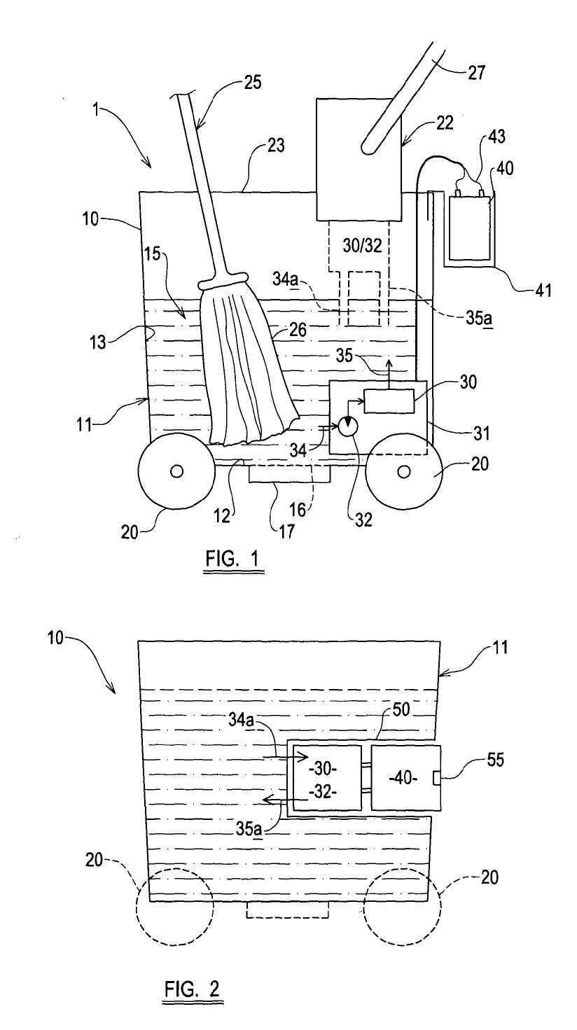

FIG. 1 is a diagrammatic side view illustration of a first bucket in accordance with an embodiment; and:

FIG. 2 is a view similar to FIG. 1 but showing aspects of another embodiment;

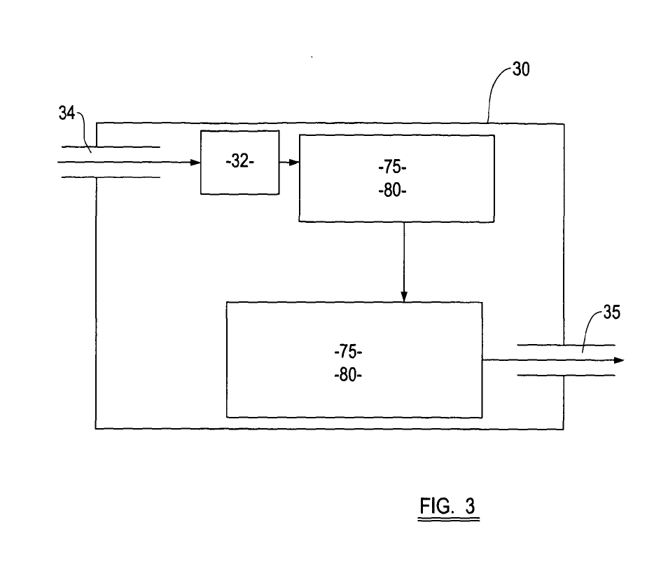

FIG. 3 is a schematic view of a treatment station of an embodiment;

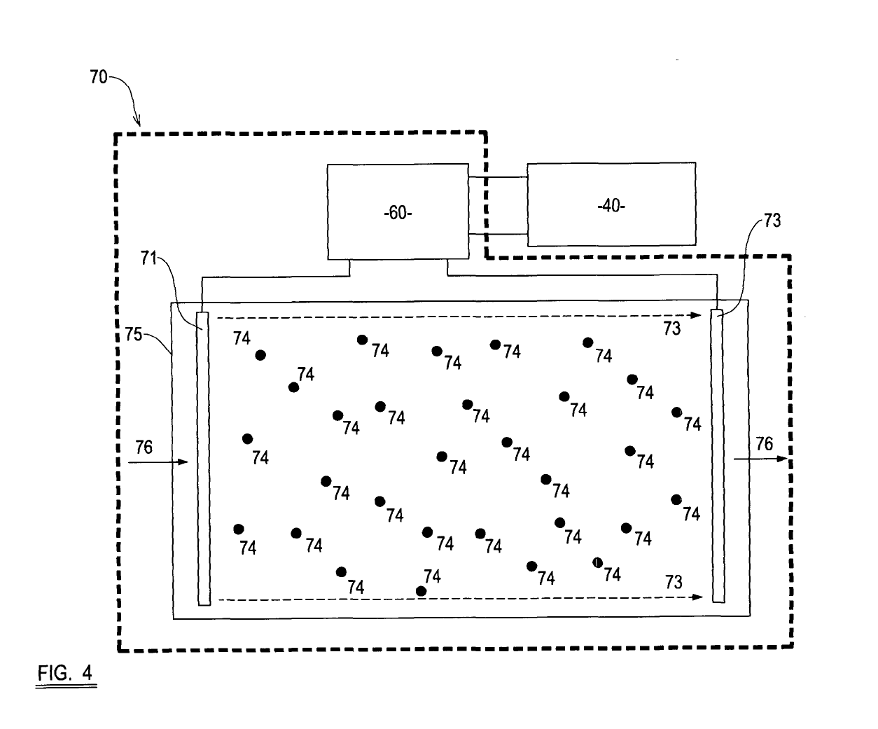

FIG. 4 is a schematic view of a part of a treatment station of an embodiment;

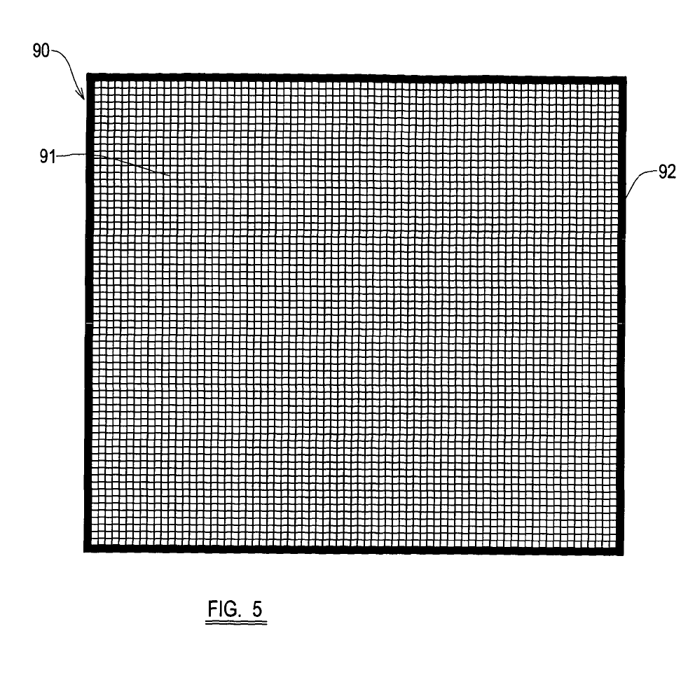

FIG. 5 is a view of a filter member of an embodiment;

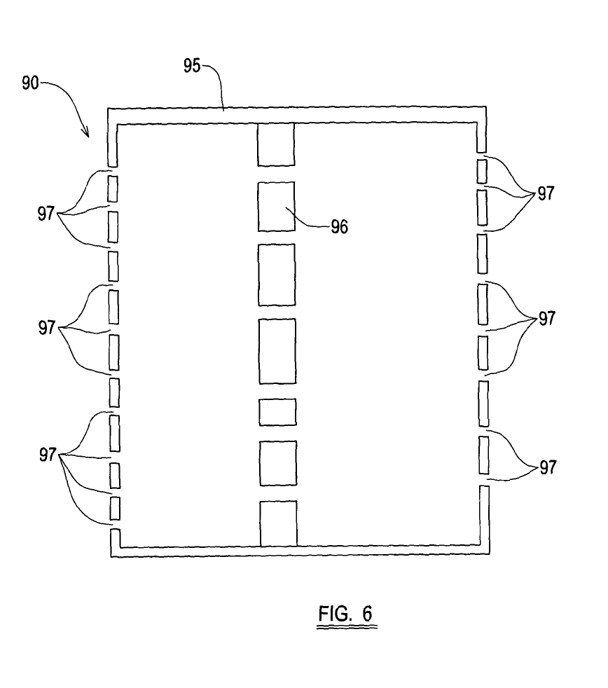

FIG. 6 is a view of a cartridge of an embodiment; and

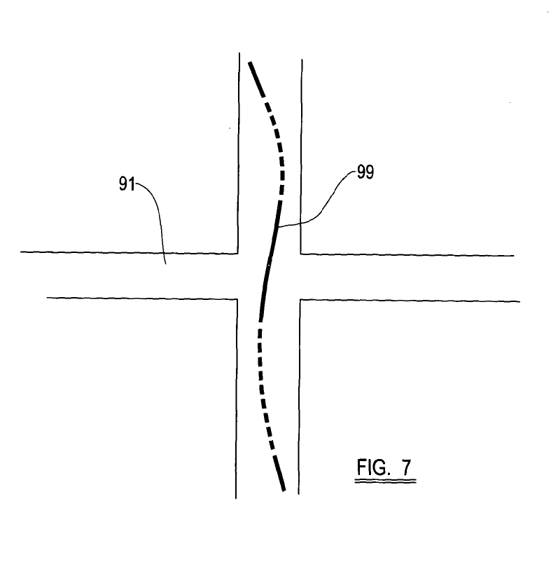

FIG. 7 is a magnified view of a part of a mesh of a filter member of an embodiment.

Referring to FIG. 1 a bucket arrangement 1 includes a bucket 10 which has a bucket wall 11 which includes a base 12 and, in this and other examples, a curved side 13, the bucket wall 11 defining a container in which in use a volume of liquid 15 may be contained. Typically the liquid is at least predominantly water which may contain a flocculating chemical, so that dirt particles which are transferred to the liquid volume 15 as described below, flocculate and sink through a grid 16 into a sump 17 in a bottom of the bucket 10.

The bucket 10 of the bucket arrangement 1, in some of the examples disclosed, is provided with two pairs of wheels 20 so that the bucket arrangement 1 can be wheeled from location to location, but in other examples the bucket arrangement 1 includes a separate wheeled platform on which the bucket 10 may be mounted and wheeled.

In the depicted and other examples, the bucket 10 is configured to hold a volume of liquid 15 for washing floors using a mop 25, and the bucket arrangement 1 may include a wringer mechanism 22 of the kind which is mounted to and supported by the bucket 10, on an uppermost rim 23 of the bucket 10 and/or partially within the bucket 10. The wringer mechanism 22 in these examples has one or a pair of jaws configured to act on mop material 26 of the mop 25 to wring the liquid from the mop material 26 when a wringing lever 27 is operated.

In other examples, the wringer mechanism 22 may be a perforate basket or the like into which the mop material 26 is pushed to effect wringing. The perforate basket being accordingly configured to receive the mop material 26 in these examples and to allow liquid wrung from the mop material 26 to pass therethrough.

In each case, whether or not a wringing mechanism 22 is provided at all, in use, liquid from the liquid volume in the bucket 10 may be transferred to a surface, such as a floor, to be washed, using the mop 25, or in the case of a bucket for holding a liquid volume for washing other surfaces, a cloth or the like. When the mop 25/cloth, or the like, is returned to the bucket arrangement 1, dirt will be transferred into the liquid volume 15 in the bucket 10.

In accordance with embodiments, the bucket arrangement includes a treatment station 30. The treatment station 30 is for treating liquid of the liquid volume 15 to kill bacteria in the liquid volume 15 and thus to prolong the period for which the liquid volume 15 may be used before the volume 15 is so soiled that a change of washing liquid is needed. The treatment station 30 may include an ultra-violet radiation source and/or one or more silver-based antibacterial devices.

In FIG. 1, it can be seen that the treatment station 30 of embodiments is located in the container defined by the bucket wall 11 of the bucket 10, on or at least towards the base 12, so that the treatment station 30 is, in use, submersed in the liquid volume in the bucket 10.

The treatment station 30 in the depicted and other examples is integrated with a pump 32 in a common housing 31, and the pump 32 is operated to pump liquid from the liquid volume 15 in the bucket 10, into an inlet 34 to the treatment station 30, through the treatment station 30, to an outlet 35 so that treated liquid is returned to the liquid volume 15. Other configurations of pump 32 may be provided in order to convey liquid from the liquid volume 15 to and/or from the treatment station 30 in accordance with embodiments. The pump 32 need not be provided in the same housing 31 as the treatment station 30 and may be coupled to the treatment station 30 by one or more conduits. It will be appreciated that the pump 32 and treatment station 30 may be provided in a common housing 31 in embodiments other than the depicted embodiment.

The pump 32 may be self-priming.

The treatment station 30, in its housing 31, is located beneath the wringer mechanism 22 in the depicted and other examples, but above the grid 16 of the sump 17. The treatment station 30 housing 31 thus does not obstruct the mop 25 significantly when the mop material 26 is placed in the bucket 10 for rinsing.

In embodiments in which the treatment station 30 includes an ultra-violet radiation source, the source includes a UV lamp as the ultra-violet radiation source. UV radiation is generated in the treatment station 30 by the UV lamp which may be isolated from the liquid in the treatment station 30 (by a panel which is transmissive to UV radiation, for example) but such that the liquid is exposed to the UV radiation, desirably as it flows through the treatment station 30.

In embodiments, the UV lamp is configured to receive electrical power from a battery pack 40 or a mains power supply (see below). The UV lamp may include one or more light emitting diodes (LEDs), bulbs, or fluorescent tubes. The UV lamp is, in embodiments, configured to output UV radiation with a wavelength of between 200 nm and 280 nm. The UV lamp is, in embodiments, configured to output UV radiation with a wavelength of between 240 nm and 280 nm. According to embodiments, the UV lamp is configured to output UV radiation of wavelengths across substantially the entire range of 200 nm to 280 nm or 240 nm to 280 nm.

In embodiments, the treatment station 30 includes a silver-based antibacterial device 70 (which may or may not include the battery pack 40 as a part thereof). The silver-based antibacterial device 70 includes at least one silver containing first electrode 71 and a second electrode 72. The silver-based antibacterial device 70 may also include a controller 60 which is configured to deliver electrical power to the first 71 and second 72 electrodes—i.e. the controller 60 applies a potential difference across the electrodes 71,72 (from the battery pack 40, for example). The first 71 and second 72 electrodes are configured such that the silver from the first electrode 71 forms silver ions 74, in use, in liquid passing through the treatment station 30 (the direction of liquid passing through the silver-based antibacterial device 70 is shown by arrows 76 in FIG. 4 but may be the opposing direction). The liquid passing through the treatment station 30 acts, therefore, as an electrolyte and the first electrode 71 acts as an anode. The second electrode 72 acts as a cathode.

The silver ions 74 released from the first electrode 71 into the liquid pass from the first electrode 71 to the second electrode 72 through the liquid (as indicated by the phantom arrows 73 in FIG. 4).

Whilst the silver ions 74 are in the liquid the ions 74 have an antibacterial effect and help to reduce the bacterial levels in the liquid.

The silver reforms at the second electrode 72—plating the second electrode 72 in silver.

In embodiments, the second electrode 72 (the cathode) is also a silver containing electrode. The controller 60 may, therefore, be configured to reverse the polarity of the potential difference across the first 71 and second 72 electrodes so that the second electrode 72 becomes the anode and the first electrode 71 becomes the cathode. Therefore, silver ions 74 are released from the second electrode 72, pass to the first electrode 71, and plate the first electrode 71 in silver, in this mode of operation.

It will be appreciated, therefore, that in such embodiments the silver of the first electrode 71 is depleted and the silver of the second electrode 72 will be built-up in a first mode of operation. The controller 60 in these embodiments is configured to reverse the polarity of the potential difference across the electrodes 71,72 such that silver of the first electrode 71 is then built-up and the silver of the second electrode 72 is depleted in a second mode of operation. Therefore, by swapping between modes of operation, it will take longer for either electrode 71, 72 to become too depleted to deliver sufficient silver ions 74 to the liquid for the antibacterial effect to be realised than would be the case if the device 70 operated only in the first mode of operation (there will inevitably be some leakage of silver ions 74).

The controller 60 may be configured to swap between the first and second modes of operation periodically throughout the operation of the treatment station 30.

The swapping of modes of operation may occur once every 1 to 30 minutes of operation. In embodiments, the swapping of modes of operation may occur more than once a minute of operation. The swapping modes of operation may occur 2 to 60 times each second of operation.

The first and/or second electrode 71,72 may include a mesh through which the liquid may pass during operation. The mesh may be coated or impregnated with silver.

In an embodiment, the first electrode 71 and second electrode 72 are coaxial—with one electrode 71,72 being a bar and the other electrode 71,72 being a tube at least partially surrounding the bar. The liquid may pass between the two electrodes 71,72 and flow axially with respect to the electrodes.

In embodiments, the first 71 and/or second 72 electrode includes one or more sub-electrodes.

The potential difference between the first and second electrodes 71,72 may be between 1V and 24V or between 1V and 12V.

In embodiments including both a silver-based antibacterial device 70 and an ultra-violet radiation source 80, the ultra-violet radiation source 80 may be provided such that the liquid between the first and second electrodes 71,72 is irradiated whilst that liquid is between the electrodes 71,72. In other such embodiments, the ultra-violet radiation source 80, and the first 71 and second 72 electrodes are provided in separate chambers 75,85 of the treatment station 30—such that liquid passes between the two electrodes 71,72 before it is irradiated with ultra-violet radiation or vice versa (generally as shown schematically in FIG. 3 with the arrows representing the flow of liquid through the treatment station 30).

As discussed above, in examples, the pump 32 and treatment station 30 need not be integrated in a common housing 31 as shown, but the treatment station 30 and pump 32 may each be provided in their own housings, which may be located together or separate as required.

In FIG. 1, there is indicated in dotted lines, an alternative location for the treatment station 30 and pump 32, namely supported beneath the wringer mechanism 22. In embodiments in which the pump 32 is thus located with the treatment station 30 (e.g. not submersed in the liquid volume 15) a pump 32 of the kind which is able to draw liquid from the liquid volume 15 up through an inlet conduit 34a would be required. Treated liquid passes from the treatment station 30 back to the liquid volume 15, via a return conduit 35a.

In another example (not shown) the pump 32 may be submersed in the liquid volume 15 and the treatment station 30 may be located and supported beneath (or to the side of) the wringer mechanism 22, or otherwise above the liquid volume (e.g. supported by the bucket wall 11).

In embodiments, a power supply for the pump 32 and for the treatment station 30 is required. In the embodiment of FIG. 1 and some other embodiments, the power supply is provided by a battery pack 40 which is located externally to the bucket 10, and carried in a carrier 41 which is attached to the bucket 10. The carrier may be “hooked over” the rim 23 of the bucket 10 as shown, or the bucket wall 11 may be provided with a specific support for the carrier 41 (e.g. integrally moulded with the bucket wall 11). In other embodiments, the battery pack 40 may be carried in a carrier which is attached to the bucket 10 such that the battery pack 40 is located beneath the bucket 10—i.e. in a position such that the battery pack 40 is located adjacent the wheels 20 (if provided) and adjacent, in use, a ground surface which supports the bucket arrangement 1. In embodiments, the battery pack 40 is carried by the separate wheeled platform (if provided). A battery pack 40 which is located in such a low position helps to provide a low centre of gravity for the bucket arrangement 1 and this is helpful in reducing the risk of the bucket arrangement 1 toppling-over, particularly when the bucket 10 is not holding a large liquid volume 15.

The battery pack 40 may be located behind a panel which is removably attached to an external surface of the bucket 10 or other part of the bucket arrangement 1.

The battery pack 40 may include a plurality of battery cells which are distributed throughout a plurality of locations with respect to the bucket arrangement 1. For example, one or more cells may be located beneath the bucket 1 and one or more cells may be located adjacent the uppermost rim 23 of the bucket 1. A plurality of electrical conductors are provided in such embodiments to connect the distributed cells together electrically.

Electrical leads 43 (or other electrical conductors) from the battery pack 40 may extend to the treatment station 30 and pump 32, either over the rim 23 of the bucket 10, as in the example, or through one or more openings which may be provided through the bucket wall 11. To avoid the need to seal such opening(s), any such opening or openings are, in embodiments, provided above the maximum liquid level for the liquid volume 15 in the bucket 10. In embodiments, the electrical leads 43 (or other electrical conductors) extend though a substantially sealed tube to the treatment station 30 and pump 32.

In embodiments, the electrical conductors are sandwiched between an inner bucket and an outer bucket—the outer bucket being configured to receive the inner bucket to form the bucket 1. In such embodiments, the treatment station 30 and/or pump 32 may also be provided between the inner and outer buckets. It will be appreciated that the inner bucket in such an arrangement may form a container for receiving the liquid volume 15 a pair of apertures may be provided through a wall of the inner bucket. Inlet 34 and outlet 35 conduits may be coupled to respective ones of the pair of apertures. The outer bucket is, in these embodiments, configured to receive the inner bucket such that a cavity is defined between the inner and outer buckets. The cavity may house the treatment station 30 and/or pump 32. The inner and outer buckets in such embodiments may be removably coupled together by one or more clips—for example—or may be substantially permanently coupled together (such that decoupling of the inner and outer bucket would require damage to one or both of the inner and other buckets). Thus, as will be appreciated, in such embodiments, the inner bucket may help to prevent the ingress of liquid from the liquid volume 15 into the treatment station 30 and/or pump 32 except through the inlet conduit 34 (i.e. except in the intended manner). The outer bucket may help to reduce the risk of leakage should there be unwanted liquid ingress into the cavity between the inner and outer buckets—thus, allowing for the continued use of the bucket 1 even if the cavity becomes flooded and even if the treatment station 30 and/or pump 32 fail as a result of such flooding.

The input 34 and output 35 conduits may be separate conduits—i.e. separate fluid flow paths.

In examples, particularly but not exclusively where the bucket 10 is carried on a wheeled platform rather than the bucket having its own wheels 20, the battery pack 40 may be carried on the wheeled platform.

Although a non-rechargeable battery pack 40 may be used according to embodiments. In embodiments, the battery pack 40 is removable from the bucket 10, with or separably from its carrier 41, for charging. In another example, a battery charger may be provided, to which a mains supply lead may be connected when it is desired to charge the battery 40, or the battery 40 may otherwise be charged in situ, from a charging lead.

In embodiments, the bucket arrangement 1 may include a transformer and rectifier which are configured to be coupled to a mains electrical supply. The transformer and rectifier are configured to reduce the voltage of the mains electrical supply and to convert the alternating current (AC) mains supply into direct current (DC) for supply to the treatment station 30 and/or pump 32. The transformer and rectifier may be carried by the bucket 1 or, for example, the separate wheeled platform (if provided). The transformer and rectifier may be separate from the bucket 1 and may be connectable thereto by electrical leads (or other electrical conductors).

Referring to FIG. 2, similar parts are indicated by the same references.

In FIG. 2, the bucket 10 has no associated wringer mechanism 22. The bucket 10 need not have a sump 17 (although this is indicated in dotted lines).

In the embodiment depicted in FIG. 2 and some other embodiments, rather than the treatment station 30 (at least) being located in the bucket 10, the treatment station 30 is externally located, although in this example still supported by the bucket wall 11.

To this end, the bucket wall 11 is provided with an integrally formed (moulded) recess 50 which in this example accommodates the treatment station 30, the pump 32 (which for illustrative purposes is shown located in an integral housing with the treatment station 30) which provides a battery compartment for the battery pack 40. Thus a liquid inlet conduit 34a and liquid conduit outlet 35a to and from the treatment station 30 from the liquid volume 15 in the bucket 10, pass though the bucket wall 11 and thus are sealed relative to the bucket wall 11 (as the recess 50 is provided below the usual liquid volume 15 level within the bucket 10).

In another example, the recess 50 may be located above the normal liquid volume 15 level in the bucket 10.

In embodiments a marker is provided with in the bucket 10 to provide the user with an indication of the maximum and/or normal liquid volume 15 levels.

The battery pack 40 may be removable from the recess 50 for charging, or the battery pack 40 may be charged in situ by connecting an external lead to a charging point 55.

In a modification to the embodiment depicted in FIG. 2, the battery pack 40 may be located in the recess 50 externally of the bucket 10, but the (combined or separate) pump 32 and treatment station 30 may be located within the bucket 10 (e.g. submersed in use in liquid in the bucket 10).

Electrical connections between the battery pack 40 and pump 32/treatment station 30, in embodiments, to pass through the bucket wall 11 and are sealed relative thereto. In embodiments, pass over the bucket rim 23. Alternatively, suitable electrical connections may be moulded integrally with the bucket wall 11.

In the embodiment depicted in FIG. 2, a wringer mechanism 22 may be provided if required.

The treatment station 30 may include a closed chamber 75, so that the UV radiation cannot be seen externally of the chamber 75: to protect users of the bucket 10 from any UV exposure generated in the treatment station 30.

Various modifications in addition to those already described may be made without departing from the scope of the invention.

For example, the buckets 10 described are moulded plastic buckets but could be fabricated in another way and in different materials. The external recess 50 in the FIG. 2 embodiment may be provided elsewhere. An external treatment station 30 and/or pump 32 may otherwise be provided, e.g. in an extreme to the liquid volume 15, carrier.

The bucket 10 need not be carried on wheels 20, but the bucket 10 may be carried by a handle. In each case the bucket 10 is portable between locations, (e.g. between a first location at which water and/or a power supply is available, and a second location).

It is envisaged that the treatment station 30 (and pump 32) may be operated by a user switching a switch. The pump 32 and treatment station 30 may then operate continuously until the switch is switched off, but if desired, the treatment station 30 may have a sensor to sensor bacteria levels in the liquid volume 15 and automatically switch on UV radiation in the treatment station 30 (and pump 32 on if not already on), when the bacteria level sensed reaches a threshold. There may be a warning device such as a display and/or audible warning device, to indicate to a user when bacteria levels are such that a liquid change is required.

In another example rather than the liquid being exposed to UV radiation and/or silver ions in the treatment station 30 as it flows, the pump 32 may pump a portion of the liquid volume 15 to the treatment station 30 where the liquid resides for a period during which the liquid is exposed to UV radiation and/or silver ions. In this case the treatment station 30 may include a reservoir for residing liquid.

It will be understood that the treatment station 30 may be provided as a standalone unit—separate from a bucket arrangement 1. In such embodiments, the treatment station 30 is configured to be positioned adjacent a sink or trough—which may include a source of liquid such as a tap (or faucet). The treatment station 30 is provided, in these embodiments, with an input and an output conduit which can be positioned relative to the sink to allow liquid in the sink to be drawn into the treatment station 30 through the input conduit, treated by the treatment station, and released through the output conduit back into the sink. As will be appreciated, in such embodiments, the treatment station 30 may include an integral pump 32.

It will also be appreciated that the treatment station 30 as disclosed herein may be retrofitted to an existing bucket or sink. This may include the locating of the treatment station 30 in a bucket 10, attaching the treatment station 30 the bucket 10, or otherwise locating the treatment station 30 such that liquid from the bucket 10 can be treated by the treatment station 30.

It will be understood that embodiments of the treatment station may be associated with wringer mechanism intend for use in relation to cleaning cloths rather than mops.

The battery pack 40 may supply electrical power between 1V and 24V or 1V and 12V.

In embodiments, there is a plurality of treatment stations 30 coupled in series or in parallel. In such embodiments, the treatment stations 30 may share certain features such as a common inlet and outlet conduits, a common pump, and/or a common controller.

It will be appreciated that in embodiments the battery pack 40 and/or the pump 32 may be part of the treatment station 30 and may be housed in a common housing 31.

As used herein, references to a “battery pack” are references to one or more battery cells—otherwise more generally referred to as a “battery”.

According to embodiments, the treatment station 30 includes one or more silver-based antibacterial devices and at least one of these devices includes a silver containing filter member which is not electrically connected to the battery pack 40 or other source of electrical power—the filter member may be provided in place or in addition to the electrodes 71,72. The filter member 90 may include a mesh 91 through which liquid may pass in order to treat the liquid—see FIG. 5. The filter member may include a woven or non-woven material through which the liquid may pass to treat the liquid. The woven or non-woven material may include one or more silver threads. In some embodiments, the filter member includes a silver containing bar of material configured such that liquid may pass over a surface of the bar in order to treat the liquid. In some embodiments, the filter member includes a silver containing bar with a longitudinal axis which is perpendicular to, or parallel with, the usual direction of the flow of liquid adjacent the bar. In some embodiments, the filter member includes an array of silver containing bars substantially as herein described.

The silver containing filter member may be a silver member. The filter member may include a frame configured to support the filter member—see the frame 92 in FIG. 5, for example. The frame may be formed of moulded plastic or another metal. In embodiments, the silver containing filter member may comprise a mesh 91 of a polymer material (such as moulded plastic) in which one or more silver threads 99 or objects are at least partially embedded such that liquid may pass over exposed portions of the silver threads or objects to treat the water—see FIG. 7 for example in which the silver thread 99 is depicted in phantom in sections to represent parts of the thread 99 which are embedded in the mesh material whilst exposed parts of the thread 99 are depicted in solid linesp.

In embodiments, two or more such filter members may be provided in series or in parallel with respect to the flow of liquid through the treatment station 30. In embodiments, one or more filter members are provided either side of the source of ultra-violet radiation, in terms of the flow of liquid—such that liquid passes through a filter member before treatment by the source of ultra-violet radiation and another filter member after treatment by the source of ultra-violet radiation. In some embodiments, the flow of liquid is such that the liquid will pass through different parts of the same filter member during operation of the treatment station 30. In some embodiments, liquid will pass through the same filter member and, indeed, may be even the same part of the same filter member, in substantially opposite directions, during the operation of the treatment station 30—for example, liquid may be drawn into a chamber of the treatment station 30 through a filter member and later ejected from the chamber through the same filter member. The liquid may, of course, be treated further whilst in the chamber—for example, by exposure to UV radiation.

In embodiments, the or each filter member is removable from the treatment station 30 to allow for the cleaning of the filter member and/or replacement thereof. In embodiments, the or each filter member is irremovable from the rest of the treatment station 30 such that removal is only possible by damaging or destroying at least part of the rest of the treatment station 30.

In some embodiments, the or each filter member 90 includes a cartridge 95—see FIG. 6 for example—which may be formed of a moulded plastic material which contains a silver containing member 96 or a plurality of such members. The cartridge may include one or more apertures 97 which allow liquid to pass into and out of the cartridge for treatment by the or each silver containing member. The or each silver containing member may be in the form of a mesh, a body of woven or unwoven material, a bar, or other object. The cartridge may define a chamber containing the or each silver containing member, with one or more of the walls of the chamber being perforated to allow the passage of liquid into and out of the chamber. The cartridge may provide some protection against damage to, or theft of, the silver containing member or members contained therein. One or more walls of the cartridge (such as one or more of perforated walls) may act as a filter for suspended particles in the liquid—helping to reduce the likelihood of the particles clogging the silver containing member (particularly if the silver containing member includes a mesh or the like) which would otherwise hinder the operation of the filter member. The wall or walls of the cartridge may be configured to allow for easy cleaning thereof to remove collected particles. In embodiments, one or more walls of the cartridge include a mounting arrangement to permit the removable mounting of a respective particle filter thereto—such that liquid passing though the cartridge must first pass through the particle filter.

In embodiments, wheels or a wheeled platform are not provided. Instead, the bucket 10 may be placed directly on a ground surface or work top and supported thereby. In embodiments, the bucket 10 may be mountable on and/or may be otherwise engaged with a support structure and the support structure is configured to support the bucket 10 with respect to a ground surface or work top—the support structure may be configured to engage the ground surface or work top directly and/or the support structure may include a flat surface for abutment against the ground surface or work top.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A bucket arrangement including:
a bucket configured to contain a volume of liquid for use in cleaning a surface;
a treatment station;
a flow path for liquid from the liquid volume to the treatment station; and
a flow path for liquid from the treatment station to return the liquid to the liquid volume after treatment by the treatment station, wherein the treatment station includes a source of ultra-violet radiation configured to expose the liquid in the treatment station to ultra-violet radiation to treat the liquid and/or a silver-based antibacterial device configured to expose the liquid in the treatment station to silver to treat the liquid.

2. A bucket arrangement according to claim 1, wherein the treatment station includes a closed chamber in which the source of ultra-violet radiation and/or silver-based antibacterial device are located.

3. A bucket arrangement according to claim 1, wherein the treatment station includes the source of ultra-violet radiation which is configured to expose the liquid to the ultra-violet radiation as the liquid flows though the treatment station.

4. A bucket arrangement according to claim 1, wherein the treatment station includes a silver-based antibacterial device which is configured to expose the liquid to silver as the liquid flows through the treatment station.

5. A bucket arrangement according to claim 1, further including a pump wherein the liquid is pumped to and/or from the treatment station by the pump.

6. (canceled)

7. A bucket arrangement according to claim 1, wherein the treatment station is configured to be submersed in the liquid volume within the bucket.

8. A bucket arrangement according to claim 1, wherein the treatment station is configured to be external to the liquid volume.

9. A bucket arrangement according to claim 8, wherein the treatment station is outside the bucket with the flow paths to and from the liquid volume passing through a bucket wall of the bucket.

10. A bucket arrangement according to claim 1, wherein the treatment station is located within the bucket.

11. A bucket arrangement according to claim 1, further including a wringer mechanism attached to the bucket and the treatment station is supported by the wringer mechanism.

12. A bucket arrangement according to claim 1, where the treatment station includes a silver-based antibacterial device which is configured to expose the liquid to silver as the liquid flows through the treatment station, wherein the silver-based antibacterial device includes a silver containing mesh.

13. A bucket arrangement according to claim 12, wherein the silver-based antibacterial device configured to expose the liquid in the treatment station to silver in the form of silver ions to treat the liquid.

14. A bucket arrangement according to claim 12, where the silver-based antibacterial device includes at least one silver containing electrode.

15. A bucket arrangement according to claim 1, further including a battery wherein electrical power for the treatment station is provided by the battery.

16. A bucket arrangement according to claim 15, wherein the battery is a re-chargeable battery.

17. (canceled)

18. A bucket arrangement according to claim 15, wherein the battery is housed within a battery compartment externally of the bucket.

19. (canceled)

20. A bucket arrangement according to claim 1, further including a mains electrical supply adaptor configured for connection to a main electrical supply.

21. A bucket arrangement according to claim 1, further including wheels attached to the bucket or a wheeled carriage attachable to the bucket.

22. A bucket arrangement according to claim 1, wherein the bucket includes a substantially flat base such that the bucket can be supported directly on a substantially flat ground surface or work top.

23. A bucket arrangement according to claim 1, wherein the bucket is configured to engage a support structure which includes a substantially flat base such that the bucket can be supported by the support structure on a substantially flat ground surface or work top.

24. (canceled)

25. (canceled)

26. (canceled)

27. (canceled)

28. (canceled)

29. (canceled)

30. (canceled)
